(19) United States
(12) Patent Application Publication
(10) Pub. No.: US 2004/0187664 A1
(43) Pub. Date: Sep. 30, 2004

(54) Cutting apparatus by high pressure fluid jet

(76) Inventors: Shimaki Hori, Nagoya-shi (JP); Tatsuya Oba, Nagoya-shi (JP); Yoshiaki Urasaki, Nagoya-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/745,682

(22) Filed: Dec. 29, 2003

(30) Foreign Application Priority Data
Dec. 27, 2002 (JP) 2002-381542

(51) Int. Cl. B26D 3/00

(52) U.S. Cl. 83/177; 83/53

(57) ABSTRACT

A cutting apparatus by a high pressure fluid jet including a super high pressure pump for increasing the pressure of a fluid so as to form a super high pressure fluid, a super high pressure fluid nozzle having an orifice, for injecting the super high pressure fluid so as to form a high rate injection flow, a super high pressure fluid pipeline for connecting the super high pressure pump and the super high pressure fluid nozzle to each other, and a switch valve interposed between the super high pressure fluid nozzle and the super high pressure fluid pipeline so as to connect or disconnect the supply of the super high pressure fluid; wherein said super high pressure fluid nozzle is provided plurality, in which the diameter of orifice provided with each nozzles is different from each other, and the supply of the super high pressure fluid from said super high pressure fluid pipeline to the super high pressure fluid nozzle is changed from one nozzle to the other nozzle in the said plural number of super high pressure fluid nozzles.

### BACKGROUND OF THE INVENTION

1. Field of the Invention

The present invention relates to a cutting method and apparatus by a high pressure fluid jet, in which a high rate injection flow is formed by injecting a super high pressure fluid from a nozzle, thus achieving cutting or the like by allowing the injection flow to collide with a workpiece.

More particularly, the present invention relates to a cutting method and apparatus by a high pressure fluid jet suitable for cutting a workpiece made of a plurality of members laminated one on another and each member has different quality of the material.

1. Description of the Related Art

There has been a conventionally known cutting apparatus by a high pressure fluid jet. Said cutting apparatus includes a super high pressure pump for increasing the pressure of a fluid so as to form a super high pressure fluid, a super high pressure fluid nozzle having very small pore called orifice and injecting the super high pressure fluid so as to form a high rate injection flow, a super high pressure fluid pipeline for connecting the super high pressure pump to the super high pressure fluid nozzle, and a switch valve being interposed between the super high pressure fluid nozzle and the super high pressure fluid pipeline, for connecting or disconnecting the supply of the super high pressure fluid. Also, there has been a conventionally known cutting method using the same.

In the before described cutting apparatus and cutting method by a high pressure fluid jet, water or oil is generally used as the fluid.

The above-described apparatus and method is applied to machining, for example, cutting a synthetic resin plate such as an urethane plate or a polypropylene plate, a metallic plate such as an aluminum plate or an iron plate, or plates made of various kinds of materials such as a wood plate and a sponge plate.

A discharge pressure can be generally adjusted in a super high pressure pump in the before described cutting apparatus by a high pressure fluid jet. It is general that machining energy, for example, cutting energy becomes greater as the discharge pressure in a super high pressure pump in the before described cutting apparatus becomes higher; in contrast, the machining energy, for example, the cutting energy becomes smaller as the discharge pressure in a super high pressure pump in the before described cutting apparatus becomes lower.

In any case, machining may be performed without increasing the discharge pressure in a super high pressure pump in the before described cutting apparatus very much according to a workpiece. For example, a workpiece made of a material which can be cut at a low pressure, is machined. Otherwise, a portion made of a material, which can be cut at a low pressure, is contained in a different material laminated member, in which a plurality of members are laminated, and only the portion made of a material, which can be cut at a low pressure, is intended to be cut.

For example, assume that the discharge pressure in a super high pressure pump in the before described cutting apparatus by a high pressure fluid jet, having a single super high pressure fluid nozzle securely fixed thereto, required when an urethane plate and a polypropylene plate are to be cut is 196 MPa and 294 MPa respectively. In this case, the machining energy (i.e., the cutting energy) required for cutting the urethane plate is smaller than that required for cutting the polypropylene plate.

When the polypropylene plate is to be cut, in the case where laminated member comprising the urethane plate and the polypropylene plate laminated one on another is cut, or when the entire laminated member comprising the urethane plate and the polypropylene plate is cut at one time, the discharge pressure in a super high pressure pump in the before described cutting apparatus is requested to be set to 294 MPa. In contrast, in the case where only the urethane plate is to be cut, the discharge pressure in a super high pressure pump in the before described cutting apparatus is requested to be set to 196 MPa.

As described above, the discharge pressure can be adjusted in the super high pressure pump. And, in general, the cutting energy is greater as the discharge pressure is higher; in contrast, the cutting energy is smaller as the discharge pressure is lower. Thus, the same super high pressure pump, the same super high pressure fluid pipeline and the same super high pressure fluid nozzle can be used in the cutting apparatus by the high pressure fluid jet adjusting the discharge pressure in the super high pressure pump according to the required machining energy (i.e., the required cutting energy), thereby achieving the cutting work using the cutting apparatus by the high pressure fluid jet without replacing super high pressure pump, super high pressure fluid pipeline, and super high pressure fluid nozzle with the others.

However, in the case where the required machining energy (i.e., the cutting energy) is achieved by adjusting the discharge pressure of the super high pressure pump in the cutting apparatus by the high pressure fluid jet while using the same super high pressure fluid pipeline, the super high pressure fluid pipeline gets fatigued, and thus, its lifetime may be markedly shortened since the super high pressure fluid pipeline is expanded or contracted according to fluctuations in pressure.

To solve the above-described problem, if another super high pressure fluid pipeline is used every time the discharge pressure of the super high pressure pump in the cutting apparatus by the high pressure fluid jet is varied according to the required machining energy (i.e., the cutting energy), there have arisen in turn problems of complication of a system and a high cost.

### SUMMARY OF THE INVENTION

In view of the above-described problems observed in the prior art, an object of the present invention is to provide a cutting method and apparatus by a high pressure fluid jet, which can provide a suitable machining energy, for example, cutting energy required for machining a workpiece without varying the discharge pressure of a super high pressure pump in the cutting apparatus by the high pressure fluid jet.

Consequently, another object of the present invention is to prevent a load such as expansion or contraction from being exerted on a super high pressure fluid pipeline even if the cutting apparatus by the high pressure fluid jet is used flexibly according to the magnitude of the machining energy (e.g., the cutting energy) required for machining the workpiece.

In order to attain the above-described objects, a cutting apparatus by the high pressure fluid jet according to the present invention includes a super high pressure pump for increasing the pressure of a fluid so as to form a super high pressure fluid, a super high pressure fluid nozzle having an orifice, for injecting the super high pressure fluid so as to form a high rate injection flow, a super high pressure fluid pipeline for connecting the super high pressure pump and the super high pressure fluid nozzle to each other, and a switch valve interposed between the super high pressure fluid nozzle and the super high pressure fluid pipeline so as to connect or disconnect the supply of the super high pressure fluid.

Wherein, a cutting apparatus by the high pressure fluid jet according to the present invention further includes a plurality of super high pressure fluid nozzles, in which the diameter of orifice provided with each nozzles is different from each other, and the supply of the super high pressure fluid to the super high pressure fluid nozzle can be changed from anyone of nozzles to the other nozzle.

A cutting method by a high pressure fluid jet proposed by the present invention is conducted by the before described cutting apparatus by the high pressure fluid jet according to the present invention. That is to say, a cutting method by a high pressure fluid jet proposed by the present invention is conducted by the cutting apparatus by the high pressure fluid jet including a super high pressure pump for increasing the pressure of a fluid so as to form a super high pressure fluid, a super high pressure fluid nozzle having an orifice, for injecting the super high pressure fluid so as to form a high rate injection flow, a super high pressure fluid pipeline for connecting the super high pressure pump and the super high pressure fluid nozzle to each other, and a switch valve interposed between the super high pressure fluid nozzle and the super high pressure fluid pipeline so as to connect or disconnect the supply of the super high pressure fluid, wherein said cutting apparatus by the high pressure fluid jet includes a plurality of super high pressure fluid nozzles, in which the diameter of orifice provided with each nozzles is different from each other, and the supply of the super high pressure fluid from said super high pressure fluid pipeline to the super high pressure fluid nozzle is changed from one nozzle to the other nozzle in the said plural number of super high pressure fluid nozzles.

In the cutting method by a high pressure fluid jet proposed by the present invention conducted by using the before described cutting apparatus by the high pressure fluid jet according to the present invention, cutting energy is varied by changing the super high pressure fluid nozzle having one orifice, to which the high pressure fluid jet is supplied from the super high pressure fluid pipeline, to the other super high pressure fluid nozzle having the other orifice, the diameter of the said other orifice is different from the one orifice, while keeping the discharge pressure of the super high pressure pump in the cutting apparatus by the high pressure fluid jet constant. Thereby, the cutting method by a high pressure fluid jet is achieved.

Between the machining energy (i.e., the cutting energy) in the cutting apparatus and cutting method by the high pressure fluid jet and the discharge pressure of the super high pressure pump in the cutting apparatus by the high pressure fluid jet, there is established the following relationship.

(the discharge pressure of the super high pressure pump)×(the flow rate of a fluid injected from the orifice formed at the super high pressure fluid nozzle)=the machining energy (i.e., the cutting energy)

Therefore, even in the case where the discharge pressure of the super high pressure pump in the cutting apparatus by the high pressure fluid jet is kept constant so as to prevent a load such as expansion or contraction from being exerted on the super high pressure fluid pipeline, the machining energy (i.e., the cutting energy) can be adjusted by adjusting the flow rate of the super high pressure fluid injected from the orifice formed at the super high pressure fluid nozzle.

Thus, the present invention is directed to that cutting energy can be varied by changing the super high pressure fluid nozzle to the other super high pressure fluid nozzle, in which the orifice formed at each super high pressure fluid nozzles has different diameter with each other, while keeping the discharge pressure of the super high pressure pump constant.

In the above-described method and apparatus according to the present invention, the cutting energy is adjusted flexibly according to the magnitude of the cutting energy required for cutting a work piece to be cut, thereby achieving the cutting work, while the load such as expansion or contraction can be prevented from being exerted on the super high pressure fluid pipeline with keeping the discharge pressure of the super high pressure pump constant and using the same super high pressure pump and the same super high pressure fluid pipeline.

In other words, in the method and apparatus according to the present invention, even in the case where a different material laminate member, in which a plurality of materials requiring different magnitudes of the cutting energy are laminated one on another, is cut, a desired cutting work can be performed while keeping the discharge pressure of the super high pressure pump constant and using the same super high pressure pump and the same super high pressure fluid pipeline.

For example, as described above, it is assumed that the urethane plate requiring the cutting energy corresponding to 196 MPa of the discharge pressure of the super high pressure pump is laminated on the polypropylene plate requiring the cutting energy corresponding to 294 MPa of the discharge pressure of the super high pressure pump. In the method and apparatus according to the present invention, in the case where the different material laminate member is to be cut, such that the before described laminate member comprising urethane plate on the polypropylene plate is to be cut, while keeping the discharge pressure of the super high pressure pump constant with using the same super high pressure pump and the same super high pressure fluid pipeline, for example, a nozzle provided with an orifice having a diameter of 8/1000 inch is used when the entire member is cut at one time; in the meantime, a nozzle provided with an orifice having a diameter of 3/1000 inch is used when only the urethane plate is cut. Thus, it is possible to achieve the cutting energy required for the cutting work in both the cases by changing the super high pressure fluid nozzle provided with an orifice having a diameter of 8/1000 inch to the other super high pressure fluid nozzle provided with an orifice having a diameter of 3/1000 inch.

To sum up, according to the present invention, the nozzle provided with the orifice having the desired diameter is used according to the material of the workpiece to be cut while keeping the discharge pressure of the super high pressure pump constant and using the same super high pressure pump and the same super high pressure fluid pipeline, thus achieving the cutting energy required for the cutting work.

According to the present invention, since the proper cutting energy can be selected by replacing the nozzle with the other nozzle provided with the orifice having the desired diameter, the cutting apparatus and method becomes economical, and further, the different kinds of plates can be readily cut by the single high pressure pump.

In this manner, since the discharge pressure of the super high pressure pump is kept constant even if different workpieces to be cut requiring the different cutting energy for the cutting work are cut, a load such as expansion or contraction cannot be exerted on the super high pressure fluid pipeline. As a consequence, it is possible to prevent any danger of occurrence of a fatigue or degradation on the super high pressure fluid pipeline, so as to remarkably prolong a useful life.

In the above-described cutting apparatus by the high pressure fluid jet according to the present invention, the switch valve for connecting or disconnecting the supply of the super high pressure fluid is provided in each of the nozzles, and thus, the super high pressure fluid pipeline of one system connects from the super high pressure pump to each of the switch valves.

Here, the connection via the super high pressure fluid pipeline of one system signifies that since the discharge pressure of the super high pressure pump is kept constant in the cutting apparatus by the high pressure fluid jet according to the present invention, the super high pressure pump is connected to each of the switch valves via one kind of super high pressure fluid pipeline suitable for the constantly kept discharge pressure. As described above, if the super high pressure fluid pipeline is one kind suitable for the constantly kept discharge pressure, a mode in which the super high pressure pump is connected to each of the switch valves via independent super high pressure fluid pipelines and a mode in which a super high pressure fluid pipeline extending from the super high pressure pump is branched toward each of a plurality of switch valves in the vicinity of the switch valves may be included in the concept of the super high pressure fluid pipeline of one system.

Furthermore, in the above-described cutting apparatus by the high pressure fluid jet according to the present invention, the super high pressure fluid nozzles may be disposed in a robot hand of a revolute robot. In this manner, the nozzle capable of achieving the desired cutting energy out of the plurality of nozzles can be exposed to a cut portion of a workpiece to be cut, thereby achieving the cutting work.

Incidentally, in the above-described method and apparatus according to the present invention, water or oil can be used as the fluid.

### BRIEF DESCRIPTION OF THE DRAWINGS

FIG. 1 is a side view showing a cutting apparatus in an embodiment according to the present invention, although a part is omitted;

FIG. 2 is a front view showing the cutting apparatus in the embodiment according to the present invention, although a part is omitted; and

FIG. 3(a) is a side view illustrating the case where only an upper layer of a laminate member is cut, and FIG. 3(b) is a side view illustrating the case where both of upper and lower layers of the laminate member are cut.

### DETAILED DESCRIPTION OF THE INVENTION

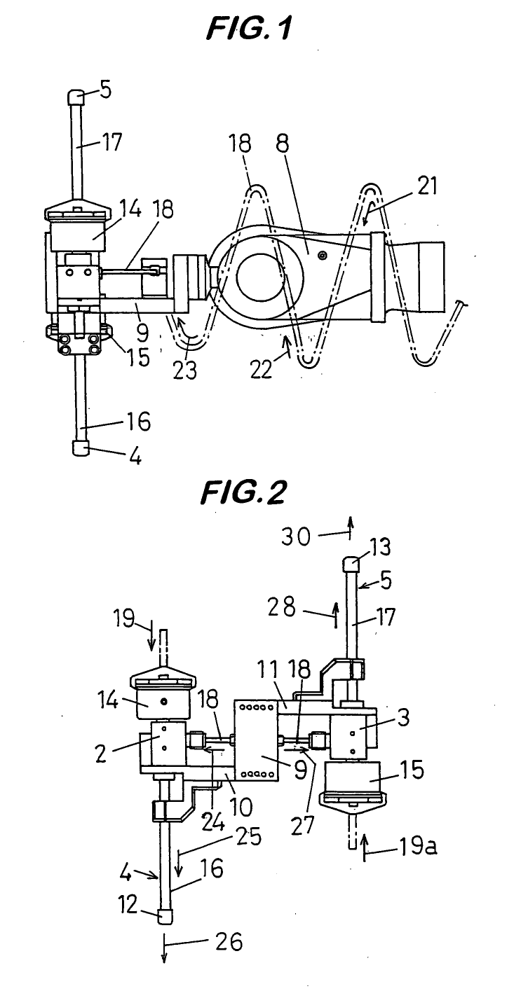

A preferred embodiment according to the present invention will be described below in reference to FIGS. 1 to 3.

As shown in FIG. 1, one end of a valve frame 9 is fixed at the tip of a robot hand 8 of a revolute robot, not shown. To the other end of the valve frame 9 are fixed switch valves 2 and 3 via fixing arms 10 and 11, respectively, as shown in FIG. 2. The switch valves 2 and 3 are connected at one end thereof to actuators 14 and 15 while at the other end thereof to one ends of nozzle tubes 16 and 17, respectively. The pore diameter of each of the nozzle tubes 16 and 17 on the side connected to the switch valves 2 and 3 is formed in a normal size.

In contrast, a nozzle 12 provided with an orifice having a diameter of 3/1000 inch and a nozzle 13 provided with an orifice having a diameter of 8/1000 inch are fixed at the other ends of the nozzle tubes 16 and 17, respectively.

To the switch valves 2 and 3 are connected a super high pressure fluid pipeline 18 connected at the base end thereof to a discharge side of a super high pressure pump, not shown. Thus, high pressure water comes up to the switch valves 2 and 3 at all times. Here, the discharge pressure of the super high pressure pump, not shown, is kept constant.

First, the tip of the nozzle 12 is exposed to a cut portion of a workpiece to be cut by moving the robot hand 8 of the revolute robot, not shown.

Subsequently, when pressurized air is supplied to the actuator 14 as indicated by an arrow 19, the switch valve 2 is opened. Then, the high pressure water flows through the super high pressure fluid pipeline 18 as indicated by arrows 21, 22, 23 and 24, and thereafter, is injected from the orifice formed at the nozzle 12, as indicated by an arrow 26, through the nozzle tube 16, as indicated by an arrow 25.

In this manner, upon completion of a desired cutting work, the supply of the pressurized air to the actuator 14 is stopped. Thus, the switch valve 2 is closed, so that the injection of the high pressure water is stopped.

Next, the tip of the nozzle 13 is exposed to the cut portion of the workpiece to be cut by moving the robot hand 8 of the revolute robot, not shown.

Subsequently, when the pressurized air is supplied to the actuator 15 as indicated by an arrow 19a, the switch valve 3 is opened. Then, the high pressure water flows through the super high pressure fluid pipeline 18 as indicated by the arrows 21, 22, 23 and 27, and thereafter, is injected from the orifice formed at the nozzle 13, as indicated by an arrow 30, through the nozzle tube 17, as indicated by an arrow 28.

In this manner, upon completion of a desired cutting work, the supply of the pressurized air to the actuator 15 is stopped. Thus, the switch valve 3 is closed, so that the injection of the high pressure water is stopped.

In the present embodiment, the workpiece 20 to be cut is a different material laminate member, in which an urethane plate 27 as an upper layer is laminated on a polypropylene plate 29 as a lower layer. Here, the discharge pressure of the super high pressure pump corresponding to the cutting energy required for cutting the urethane plate, while using the same super high pressure fluid pipeline and single super high pressure fluid nozzle securely fixed thereto are used, is set to 196 MPa; in contrast, the discharge pressure of the super high pressure pump corresponding to the cutting energy required for cutting the polypropylene plate is set to 294 MPa.

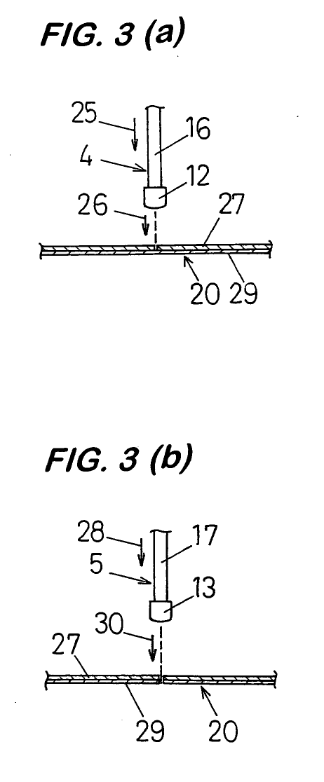

In this case, in the above-described embodiment according to the present invention, the high pressure water is injected from the nozzle 12 provided with the orifice having a diameter of 3/1000 inch while the discharge pressure of the super high pressure pump, not shown, is kept constant, so that only the urethane plate 27, which can be cut at a small cutting energy, can be cut, as shown in FIG. 3(a).

Moreover, the high pressure water is injected from the nozzle 13 provided with the orifice having a diameter of 8/1000 inch while the discharge pressure of the super high pressure pump, not shown, is kept constant, so that the polypropylene plate 29 requiring a large cutting energy in cutting can be cut, as shown in FIG. 3(b).

Alternatively, only the urethane plate 27 may be first cut by the injection of the high pressure water from the nozzle 12, and then, the polypropylene plate 29 may be cut by the injection of the high pressure water from the nozzle 13. Otherwise, the high pressure water may be first injected from the nozzle 13, so that the urethane plate 27 and the polypropylene plate 29 may be cut at the same time.

Although the present invention has been described with reference to preferred embodiment thereof, it should be understood that the present invention is not limited to the before described embodiment, and various changes or modifications may be made to the embodiment without departing from the spirit and scope of the invention as defined in the appended claims.

What is claimed is:

1. A cutting apparatus by a high pressure fluid jet including;
a super high pressure pump for increasing the pressure of a fluid so as to form a super high pressure fluid,
a super high pressure fluid nozzle having an orifice, for injecting the super high pressure fluid so as to form a high rate injection flow,
a super high pressure fluid pipeline for connecting the super high pressure pump and the super high pressure fluid nozzle to each other, and
a switch valve interposed between the super high pressure fluid nozzle and the super high pressure fluid pipeline so as to connect or disconnect the supply of the super high pressure fluid; wherein
said super high pressure fluid nozzle is provided plurality, in which the diameter of orifice provided with each nozzles is different from each other, and
the supply of the super high pressure fluid from said super high pressure fluid pipeline to the super high pressure fluid nozzle is changed from one nozzle to the other nozzle in the said plural number of super high pressure fluid nozzles.

2. A cutting apparatus by a high pressure fluid jet according to claim 1, wherein the switch valve for connecting or disconnecting the supply of the super high pressure fluid is provided in each of the nozzles, and thus, the super high pressure fluid pipeline of one system connects from the super high pressure pump to each of the switch valves.

3. A cutting apparatus by a high pressure fluid jet according to claim 1, wherein the plurality of super high pressure fluid nozzles are disposed in a robot hand of a revolute robot.

4. A cutting apparatus by a high pressure fluid jet according to claim 2, wherein the plurality of super high pressure fluid nozzles are disposed in a robot hand of a revolute robot.
